(19) United States
(12) Patent Application Publication
(10) Pub. No.: US 2013/0197145 A1
(43) Pub. Date: Aug. 1, 2013

(54) THERMOPLASTIC MELT-MIXED COMPOSITION WITH POLYACID METAL SALT HEAT STABILIZER

(71) Applicants: Jennifer L. Thompson, Newark, DE (US); Toshikazu Kobayashi, Chadds Ford, PA (US)

(72) Inventors: Jennifer L. Thompson, Newark, DE (US); Toshikazu Kobayashi, Chadds Ford, PA (US)

(73) Assignee: E. I. DU PONT DE NEMOURS AND COMPANY, Wilmington, DE (US)

(21) Appl. No.: 13/359,627

(22) Filed: Jan. 27, 2012

(51) Int. Cl. C08K 5/098

(52) U.S. Cl. 524/397

(57) ABSTRACT

Disclosed is a thermoplastic melt-mixed composition including a) a polyamide resin b) about 1.0 to about 5.0 weight percent of a polyacid metal salt selected from the group consisting of citrate metal salts, malate metal salts, tartarate metal salts and combinations thereof, c) 10 to 60 weight percent reinforcing agent; and, optionally, 0 to 30 weight percent polymeric toughener; and molded or extruded thermoplastic articles made therefrom.

### FIELD OF INVENTION

The present invention relates to the field of polyamide compositions having improved long-term high temperature aging characteristics.

### BACKGROUND OF INVENTION

High temperature resins based on polyamides possess desirable chemical resistance, processability and heat resistance. This makes them particularly well suited for demanding high performance automotive and electrical/electronics applications. There is a current and general desire in the automotive field to have high temperature resistant structures since temperatures higher than 150° C., even higher than 200° C., are often reached in underhood areas of automobiles. When plastic parts are exposed to such high temperatures for a prolonged period, such as in automotive under-the-hood applications or in electrical/electronics applications, the mechanical properties generally tend to decrease due to the thermo-oxidation of the polymer. This phenomenon is called heat aging.

In an attempt to improve heat aging characteristics, it has been the conventional practice to add heat stabilizers (also referred as antioxidants) to thermoplastic compositions comprising polyamide resins. Examples of such heat stabilizers include hindered phenol antioxidants, amine antioxidants and phosphorus-based antioxidants. For polyamide compositions, three types of heat stabilizers are conventionally used to retain the mechanical properties of the composition upon exposure to high temperatures. One is the use of phenolic antioxidants optionally combined with a phosphorus based synergist as previously mentioned, the use of aromatic amines optionally combined with a phosphorus based synergist and the third one is the use of copper salts and derivatives. Phenolic antioxidants are known to improve the mechanical/physical properties of the thermoplastic composition up to an aging temperature of 120° C.

U.S. Pat. No. 5,965,652 discloses a thermally stable polyamide molding composition containing colloidal copper formed in situ. However, the disclosed compositions exhibit retention of impact strength only for a heat aging at 140° C.

GB patent 839,067 discloses a polyamide composition comprising a copper salt and a halide of a strong organic base. However, the disclosed compositions exhibit improved bending heat stability performance only for a heat aging at 170° C.

US 2006/0155034 and US 2008/0146718 patent publications disclose polyamide compositions comprising a metal powder as thermal stabilizer with a fibrous reinforcing agent. Disclosed compositions exhibit improved mechanical properties such as tensile strength and elongation at break upon long-term heat aging at 215° C. However, such metal powders are not only expensive but they are also highly unstable because they are prone to spontaneous combustion.

EP 1041109 discloses a polyamide composition comprising a polyamide resin, a polyhydric alcohol having a melting point of 150 to 280° C., that has good fluidity and mechanical strength and is useful in injection welding techniques.

JP 1993043798(A) discloses a composition comprising a metallic chelating agent including EDTA, and a mixture of a polyamide, a modified polyolefin resin, and a polypropylene resin, with high metal halide resistance.

U.S. Pat. No. 5,130,198 discloses polymeric containing compositions having improved oxidative stability having a polymer and at least two stabilizing agents including an ethylene diamine tetra-acetic acid compound. The ethylene diamine tetra-acetic acid compound is incorporated into a glass “sizing” coating, the coated glass be useful in preparing glass reinforced molding resins having improved oxidative stability. U.S. Pat. No. 4,602,058 discloses a blend comprising (a) polyamide, (b) ethylene copolymer containing carboxylic acid groups; and a minor amount of organic carboxylic acid that has improved compatibility and thermal stability in hot melt adhesive applications. JP 4934749 discloses a fiber composition comprising polyamide (PA6 exemplified) and multi-carboxylic acids containing nitrogen and their salts, that has improved oxidative stability when treated with an aqueous hydrogen peroxide/hydroxyl amine mixture. JP 47013862 discloses a molded article or fiber comprising a polyamide that is surface treated with a chelating chemical solution including nitrogen containing carboxylic acids including EDTA to improve stability.

US 2010-0029819 A1 discloses molded or extruded thermoplastic article having high heat stability over at least 500 hours at least 170 C.° including a thermoplastic resin; one or more polyhydric alcohols having more than two hydroxyl groups and a having a number average molecular weight of less than 2000; one or more reinforcement agents; and optionally, a polymeric toughener.

Unfortunately, with the existing technologies, molded articles based on polyamide compositions either suffer from an unacceptable deterioration of their mechanical properties upon long-term high temperature exposure or they are very expensive due to the use of high-cost heat stabilizers.

There remains a need for low-cost polyamide compositions that are suitable for manufacturing articles and that exhibit good mechanical properties after long-term high temperature exposure.

### SUMMARY

One embodiment is a thermoplastic melt-mixed composition comprising:
a) a polyamide resin;
b) about 1.0 to about 5.0 weight percent of a polyacid metal salt selected from the group consisting of citrate metal salts, malate metal salts, tartarate metal salts and combinations thereof;
c) 10 to 60 weight percent reinforcing agent; and
d) 0 to 30 weight percent polymeric toughener;
   wherein the weight percents of components a), b), c) and d) are based on the total weight of the thermoplastic melt-mixed composition.

Another embodiment is a molded or extruded thermoplastic article comprising the thermoplastic melt-mixed composition.

### DETAILED DESCRIPTION

For the purposes of the description, unless otherwise specified, “high-temperature” means a temperature at or higher than 170° C., preferably at or higher than 210° C., and most preferably at or higher than 230° C.

In the present invention, unless otherwise specified, “long-term” refers to an aging period equal or longer than 500 hrs.

As used herein, the term “high heat stability”, as applied to the polyamide composition disclosed herein or to an article made from the composition, refers to the retention of physical properties (for instance, tensile strength) of 2 mm thick molded test bars consisting of the polyamide composition that are exposed to air oven aging (AOA) conditions at a test temperature at 170° C. for a test period of at least 500 h, in an atmosphere of air, and then tested according to ISO 527-2/1 BA method. The physical properties of the test bars are compared to that of unexposed controls that have identical composition and shape, and are expressed in terms of “% retention”. In another preferred embodiment the test temperature is at 210° C., the test period is at 500 hours and the exposed test bars have a % retention of tensile strength of at least 50%. Herein “high heat stability” means that said molded test bars, on average, meet or exceed a retention for tensile strength of 50% when exposed at a test temperature at 170° C. for a test period of at least 500 h. Compositions exhibiting a higher retention of physical properties for a given exposure temperature and time period have better heat stability.

The terms “at 170° C.,” “at 210° C.” and “at 230° C.” refer to the nominal temperature of the environment to which the test bars are exposed; with the understanding that the actual temperature may vary by +/−2° C. from the nominal test temperature.

The term “(meth)acrylate” is meant to include acrylate esters and methacrylate esters.

One embodiment of the invention is a thermoplastic melt-mixed composition comprising:
a) a polyamide resin;
b) about 1.0 to about 5.0 weight percent of a polyacid metal salt selected from the group consisting of citrate metal salts, malate metal salts, tartarate metal salts and combinations;
c) 10 to 60 weight percent reinforcing agent; and
d) 0 to 30 weight percent polymeric toughener;
   wherein the weight percents of components a), b), c) and d) are based on the total weight of the thermoplastic melt-mixed composition.

In another embodiment the thermoplastic melt-mixed composition may consist essentially of components a), b), c), and d), as disclosed above.

In another embodiment the thermoplastic melt-mixed composition comprises 40 to about 89 weight percent of a polyamide resin; about 1.0 to about 5.0 weight percent of polyacid metal salt as disclosed above, 10 to about 55 weight percent reinforcing agent and, optionally, up to 30 weight percent polymeric toughener.

The polyamide resin useful in the present invention has a melting point and/or glass transition. Herein melting points and glass transitions are as determined with differential scanning calorimetry (DSC) at a scan rate of 10° C./min in the first heating scan, wherein the melting point is taken at the maximum of the endothermic peak and the glass transition, if evident, is considered the mid-point of the change in enthalpy. Polyamides are condensation products of one or more dicarboxylic acids and one or more diamines, and/or one or more aminocarboxylic acids, and/or ring-opening polymerization products of one or more cyclic lactams. Suitable cyclic lactams are caprolactam and laurolactam. Polyamides may be fully aliphatic or semi-aromatic. Fully aliphatic polyamides used in the resin composition of the present invention are formed from aliphatic and alicyclic monomers such as diamines, dicarboxylic acids, lactams, aminocarboxylic acids, and their reactive equivalents. A suitable aminocarboxylic acid is 11-aminododecanoic acid. Suitable lactams are caprolactam and laurolactam. In the context of this invention, the term “fully aliphatic polyamide” also refers to copolymers derived from two or more such monomers and blends of two or more fully aliphatic polyamides. Linear, branched, and cyclic monomers may be used.

Carboxylic acid monomers comprised in the fully aliphatic polyamides include, but are not limited to aliphatic carboxylic acids, such as for example adipic acid (C6), pimelic acid (C7), suberic acid (C8), azelaic acid (C9), decanedioic acid (C10), dodecanedioic acid (C12), tridecanedioic acid (C13), tetradecanedioic acid (C14), and pentadecanedioic acid (C15). Diamines can be chosen among diamines having four or more carbon atoms, including, but not limited to tetramethylene diamine, hexamethylene diamine, octamethylene diamine, decamethylene diamine, dodecamethylene diamine, 2-methylpentamethylene diamine, 2-ethyltetramethylene diamine, 2-methyloctamethylenediamine; trimethylhexamethylenediamine, meta-xylylene diamine, and/or mixtures thereof.

The semi-aromatic polyamide is a homopolymer, a copolymer, a terpolymer or more advanced polymers formed from monomers containing aromatic groups. One or more aromatic carboxylic acids may be terephthalate or a mixture of terephthalate with one or more other carboxylic acids, such as isophthalic acid, phthalic acid, 2-methyl terephthalic acid and naphthalic acid. In addition, the one or more aromatic carboxylic acids may be mixed with one or more aliphatic dicarboxylic acids, as disclosed above. Alternatively, an aromatic diamine such as meta-xylylene diamine (MXD) can be used to provide a semi-aromatic polyamide, an example of which is MXD6, a homopolymer comprising MXD and adipic acid.

Preferred polyamides disclosed herein are homopolymers or copolymers wherein the term copolymer refers to polyamides that have two or more amide and/or diamide molecular repeat units. The homopolymers and copolymers are identified by their respective repeat units. For copolymers disclosed herein, the repeat units are listed in decreasing order of mole % repeat units present in the copolymer. The following list exemplifies the abbreviations used to identify monomers and repeat units in the homopolymer and copolymer polyamides (PA):
HMD hexamethylene diamine (or 6 when used in combination with a diacid)
T Terephthalic acid
AA Adipic acid
DMD Decarnethylenediamine
6 ε-Caprolactam
DDA Decanedioic acid
DDDA Dodecanedioic acid
I Isophthalic acid
MXD meta-xylylene diamine
TMD 1,4-tetramethylene diamine
4T polymer repeat unit formed from TMD and T
6T polymer repeat unit formed from HMD and T
DT polymer repeat unit formed from 2-MPMD and T
MXD6 polymer repeat unit formed from MXD and AA
66 polymer repeat unit formed from HMD and AA
10T polymer repeat unit formed from DMD and T
410 polymer repeat unit formed from TMD and DDA
510 polymer repeat unit formed from 1,5-pentanediamine and DDA
610 polymer repeat unit formed from HMD and DDA
612 polymer repeat unit formed from HMD and DDDA
6 polymer repeat unit formed from ε-caprolactam
11 polymer repeat unit formed from 11-aminoundecanoic acid
12 polymer repeat unit formed from 12-aminododecanoic acid
   Note that in the art the term “6” when used alone designates a polymer repeat unit formed from ε-caprolactam. Alternatively “6” when used in combination with a diacid such as T, for instance 6T, the “6” refers to HMD. In repeat units comprising a diamine and diacid, the diamine is designated first. Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

In one embodiment the polyamide resin comprises a one or more polyamides selected from the group consisting of:
Group (I) Polyamides having said melting point of less than 210° C., and comprising an aliphatic or semi-aromatic polyamide selected from the group poly(pentamethylene decanediamide) (PA510), poly(pentamethylene dodecanediamide) (PA512), poly(ε-caprolactam/hexamethylene hexanediamide) (PA6/66), poly(ε-caprolactam/hexamethylene decanediamide) (PA6/610), poly(ε-caprolactam/hexamethylene dodecanediamide) (PA6/612), poly(hexamethylene tridecanediamide) (PA613), poly(hexamethylene pentadecanediamide) (PA615), poly(ε-caprolactam/tetramethylene terephthalamide) (PA6/4T), poly(ε-caprolactam/hexamethylene terephthalamide) (PA6/6T), poly(ε-caprolactam/decamethylene terephthalamide) (PA6/10T), poly(ε-caprolactam/dodecamethylene terephthalamide) (PA6/12T), poly(hexamethylene decanediamide/hexamethylene terephthalamide) (PA610/6T), poly(hexamethylene dodecanediamide/hexamethylene terephthalamide) (PA612/6T), poly(hexamethylene tetradecanediamide/hexamethylene terephthalamide) (PA614/6T), poly(ε-caprolactam/hexamethylene isophthalamide/hexamethylene terephthalamide) (PA6/61/6T), poly(ε-caprolactam/hexamethylene hexanediamide/hexannethylene decanediamide) (PA6/66/610), poly(ε-caprolactam/hexamethylene hexanediamide/hexamethylene dodecanediamide) (PA6/66/612), poly(ε-caprolactam/hexamethylene hexanediamide/hexamethylene decanediamide/hexamethylene dodecanediamide) (PA6/66/610/612), poly(2-methylpentamethylene hexanediamide/hexamethylene hexanediamide/hexamethylene terephthamide) (PA D6/66/6T), poly(2-methylpentamethylene hexanediamide/hexamethylene hexanediamide/) (PA D6/66), poly(decamethylene decanediamide) (PA1010), poly(decamethylene dodecanediamide) (PA1012), poly(decamethylene decanediamide/decamethylene terephthalamide) (PA1010/10T) poly(decamethylene decanediamide/dodecamethylene decanediamide/decamethylene terephthalamide/dodecamethylene terephthalamide (PA1010/1210/10T/12T), poly(11-aminoundecanamide) (PA11), poly(11-aminoundecanamide/tetramethylene terephthalamide) (PA11/4T), poly(11-aminoundecanamide/hexamethylene terephthalamide) (PA11/6T), poly(11-aminoundecanamide/decamethylene terephthalamide) (PA11/10T), poly(11-aminoundecanamide/dodecamethylene terephthalamide) (PA11/12T), poly(12-aminododecanamide) (PA12), poly(12-aminododecanamide/tetramethylene terephthalamide) (PA12/4T), poly(12-aminododecanamide/hexamethylene terephthalamide) (PA12/6T), poly(12-aminododecanamide/decamethylene terephthalamide) (PA12/10T) poly(dodecamethylene dodecanediamide) (PA1212), and poly(dodecamethylene dodecanediamide/dodecamethylene dodecanediamide/dodecamethylene terephthalamide)) (PA1212/12T); Group (II) Polyamides having said melting point of at least 210° C., and comprising an aliphatic polyamide selected from the group consisting of poly(tetramethylene hexanediamide) (PA46), poly(ε-caprolactam) (PA 6), poly(hexamethylene hexanediamide/(ε-caprolactam/) (PA 66/6) poly(hexamethylene hexanediamide) (PA 66), poly(hexamethylene hexanediamide/hexamethylene decanediamide) (PA66/610), poly(hexamethylene hexanediamide/hexamethylene dodecanediamide) (PA66/612), poly(hexamethylene hexanediamide/decamethylene decanediamide) (PA66/1010), poly(hexamethylene decanediamide) (PA610), poly(hexamethylene dodecanediamide) (PA612), poly(hexamethylene tetradecanediamide) (PA614), poly(hexamethylene hexadecanediamide) (PA616), and poly(tetramethylene hexanediamide/2-methylpentamethylene hexanediamide) (PA46/D6); wherein within Group (II) Polyamides are Group (IIA) Polyamides having a melting point of at least 210° C. and less than 230° C. and Group (IIB) Polyamides having a melting point of 230° C. or greater;
Group (III) Polyamides having a melting point of greater than 230° C., and comprising (aa) about 20 to about 35 mole percent semi-aromatic repeat units derived from monomers selected from one or more of the group consisting of:
(i) aromatic dicarboxylic acids having 8 to 20 carbon atoms and aliphatic diamines having 4 to 20 carbon atoms; and
   (bb) about 65 to about 80 mole percent aliphatic repeat units derived from monomers selected from one or more of the group consisting of:
      (ii) an aliphatic dicarboxylic acid having 6 to 20 carbon atoms and said aliphatic diamine having 4 to 20 carbon atoms; and
      (iii) a lactam and/or aminocarboxylic acid having 4 to 20 carbon atoms;
Group (IV) Polyamides having a melting point of greater than 230° C., comprising (cc) about 50 to about 95 mole percent semi-aromatic repeat units derived from monomers selected from one or more of the group consisting of:
   (i) aromatic dicarboxylic acids having 8 to 20 carbon atoms and aliphatic diamines having 4 to 20 carbon atoms; and
   (dd) about 5 to about 50 mole percent aliphatic repeat units derived from monomers selected from one or more of the group consisting of:
      (ii) an aliphatic dicarboxylic acid having 6 to 20 carbon atoms and said aliphatic diamine having 4 to 20 carbon atoms; and
      (iii) a lactam and/or aminocarboxylic acid having 4 to 20 carbon atoms;
Group (V) Polyamides having a melting point of at least 260° C., and comprising
   (ee) greater than 95 mole percent semi-aromatic repeat units derived from monomers selected from one or more of the group consisting of:
      (i) aromatic dicarboxylic acids having 8 to 20 carbon atoms and aliphatic diamines having 4 to 20 carbon atoms; and
   (ff) less than 5 mole percent aliphatic repeat units derived from monomers selected from one or more of the group consisting of:
      (ii) an aliphatic dicarboxylic acid having 6 to 20 carbon atoms and said aliphatic diamine having 4 to 20 carbon atoms;
      (iii) a lactam and/or aminocarboxylic acid having 4 to 20 carbon atoms; and
Group (VI) Polyamides having no melting point and selected from the group consisting of poly(hexamethylene isophthalamide/hexamethylene terephthalamide) (6I/6T) and poly(hexamethylene isophthalamide/hexamethylene terephthalamide/hexamethylene hexanediamide) (6I/6T/66).

Group (IIA) Polyamides have a melting point of at least 210° C. and less than 230° C. and include aliphatic polyamides selected from the group consisting of poly(ε-caprolactam) (PA 6), poly(hexamethylene hexanediamide/(ε-caprolactam/) (PA 66/6) poly(hexamethylene hexanediamide/hexamethylene decanediamide) (PA66/610), poly(hexamethylene hexanediamide/hexamethylene dodecanediamide) (PA66/612), poly(hexamethylene hexanediamide/decamethylene decanediamide) (PA66/1010), poly(hexamethylene decanediamide) (PA610), poly(hexamethylene dodecanediamide) (PA612), poly(hexamethylene tetradecanediamide) (PA614), poly(hexamethylene hexadecanediamide) (PA616), and poly(tetramethylene hexanediamide/2-methylpentamethylene hexanediamide) (PA461D6). The artisan recognizes that several of the Group (IIA) Polyamides melting points including PA 66/6, PA66/610, and PA46/D6, depend upon the ratio of repeat units, and thus Group (IIA) Polyamides have a ratio of repeat units that meets the requirement of having a melting point of greater than 230° C.

Group (IIB) Polyamides have a melting point of greater than 230° C. and comprise an aliphatic polyamide selected from the group consisting of: poly(tetramethylene hexanediamide) (PA46), poly(hexamethylene hexanediamide/(ε-caprolactam/) (PA 66/6), poly(hexamethylene hexanediamide) (PA 66), poly(hexamethylene hexanediamide/hexamethylene decanediamide) (PA66/610), and poly(tetramethylene hexanediamide/2-methylpentamethylene hexanediamide) (PA461D6). The artisan recognizes that several of the Group (IIB) Polyamides melting points including PA 66/6, PA66/610, and PA46/D6, depend upon the ratio of repeat units, and thus Group (IIB) Polyamides have a ratio of repeat units that meets the requirement of having a melting point of at least 210° C. and less than 230° C.

In one embodiment the polyamide resin comprises one or more polyamides selected from the group consisting of Group (III) Polyamides, Group (IV) Polyamides, Group (V) Polyamides and Group (VI) Polyamides. In another embodiment the polyamide resin comprises one or more polyamides selected from the group consisting of Group (III) Polyamides, Group (IV) Polyamides, and Group (V) Polyamides.

The composition comprises about 1.0 to about 5.0 weight percent of a polyacid metal salt selected from the group consisting of citrate metal salts, malate metal salts, tartarate metal salts and combinations thereof. In preferred embodiments the melt-mixed composition comprises about 1.2 to 5.0 weight percent, about 1.2 to 4.0 weight percent or about 1.4 to 4.0 weight percent of the polyacid metal salt based on the total weight of the melt-mixed composition. The polyacid metal salt comprises at least two or more carboxylic acid metal salts represented by the general formula —CO₂Y; The carboxylic acid salt can have a single counter-ion or be a mixture of counter-ions.

The carboxylic acid salt groups are available from a parent carboxylic acid by neutralization of the parent carboxylic acid with appropriate metal hydroxides or oxides, ammonium hydroxide, or by ion exchange. Useful carboxyl acid salts include monovalent ion salts, such as Li, Na, K, ammonium and phosphonium ions; divalent ion salts such as Mg, Ca, Ba, Cu, Fe(II) salts; trivalent ion salts such as Fe (III) salts; and tetravalent salts such as Ti (IV) and Zr (IV) salts. Additionally, the carboxyl acid salts can comprise a mixture of ions such as Na and K ions, Ca and Mg, Na and Cu (I), Na and Cu (II), Na and Fe (II), and Na and Fe (III), to mention a few of the mixtures of salts available by appropriate neutralization of the parent amino acids.

Herein the term ammonium ion and phosphonium ion refers to the general classes of R₄N⁺ and R₄P⁺ ions wherein R is, independently, selected from the group consisting of H, C₁-C₁₈ linear or branched alkyl, and phenyl; wherein the linear or branched alkyl groups may have one or two sites of unsaturation, and wherein the linear or branched alkyl groups may be interrupted by one to three heteroatoms selected from oxygen and sulfur. Phosphonium ions may be wherein R is, independently, selected from the group consisting of C₁-C₁₈ linear or branched alkyl. Ammonium ions may be wherein R is, independently, selected from the group consisting of H, C₁-C₁₈ linear or branched alkyl. Ammonium ions may be wherein R is, independently, selected from the group consisting of H, C₁-C₁₀ linear or branched alkyl, and preferably wherein R is, independently, selected from the group consisting of H, C₁-C₄ linear or branched alkyl. A preferred ammonium ion is NH₄⁺.

The polyacid metal salt counter-ion Y is 1/×M^{+X} wherein x is an integer of 1 to 7, and M is a metal ion, ammonium ion or phosphonium ion. The acronym and common names for polyacid metal salts and various CAS No. for specific polyacid metal salts are listed in Table 1. Specific M^{+X} counterions useful in the carboxylate salts are listed in Table 2; and the structures for the polyacid metal salts are listed in Table 3.

TABLE 1
polyacid metal salts.

| Acronym | Common Name | Formula | CAS No. |
|---|---|---|---|
| Malic Acid-Na2 | D,L-Malic acid disodium | 2Y = Na⁺¹ | 676-46-0 |
| | salt | | |
| Tartaric Acid- | Tartaric acid iron(III) salt | 2Y = 2/3Fe³⁺ | 2944-68-5 |
| Fe(III) | | | |
| Tartaric Acid- | Tartartic acid potassium | 1Y = K⁺¹, | 6381-59-5 |
| KNa | sodium salt | 1Y = Na⁺¹ | |
| Citric Acid | Citric acid | 3Y = H | 77-92-9 |
| Citrate-Na3 | Citric acid trisodium salt | 3Y = Na⁺¹ | 6132-04-3 |
| Citrate-Fe(III) | Citric acid iron(III) salt | 3Y = ⅓Fe⁺³ | 3522-50-7 |

1/x means that the metal ion may be associated with x counterions, at least one of the listed compound and other counterions.

TABLE 2
Metal Salts
Metal salts contain at least on metal ion/acid pair, can contain
mixtures of metals and can also include hydrates.

| Metal | | |
|---|---|---|
| Oxidation | | |
| State | Y Defined | Examples |
| +1 | Y = M⁺¹ | Li⁺¹, Na⁺¹, K⁺¹, Cu⁺¹, Zn⁺¹, Ag⁺¹, Ni⁺¹ |
| +2 | Y = ½ M⁺² | Mg⁺², Ca⁺², Ba⁺², Cu⁺², Zn⁺², Ag⁺², Fe⁺², |
| | | Mn⁺², Co⁺², Ni⁺², Sn⁺², Pb⁺², As⁺² |
| +3 | Y = ⅓ M⁺³ | Ti⁺³, Cr⁺³, Fe⁺³, Co⁺³, Ni⁺³, Ag⁺³, Sb⁺³, As⁺³, |
| | | Mn⁺³ |
| +4 | Y = ¼ M⁺⁴ | Ti⁺⁴, Mn⁺⁴, Ni⁺⁴, Ge⁺⁴, Sn⁺⁴, Pb⁺⁴ |
| +5 | Y = ⅕ M⁺⁵ | Sb⁺⁵ |
| +6 | Y = ⅙ M⁺⁶ | Mn⁺⁶ |
| +7 | Y = 1/7 M⁺⁷ | Mn⁺⁷ |

TABLE 3
Structures of polyacid metal salts

| Acronym | Structure |
|---|---|
| Malic Acid | 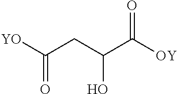 |
| Tartaric Acid | 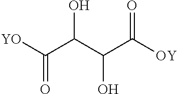 |
| Citric Acid | 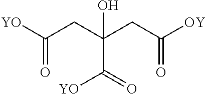 |

In a preferred embodiment the polyacid metal salts useful in the composition is selected from the group consisting of sodium, potassium, copper (I), copper (II), iron (II), Iron (III) salts, and mixtures thereof. Within this context the term “and mixtures thereof” means that any combination the sodium, potassium, copper (I), copper (II), iron (II), and Iron (III) salts may be used. For instance a mixture of sodium and copper (I) salts of may be used; a mixture of sodium and copper (II) salts can be used and a mixture of sodium copper (II) and iron (III) salts can be used. The mixtures of salts can be made “in situ” by appropriate addition of reagents to the melt mixed blend.

Preferred amino acid thermal stabilizers for the thermoplastic melt-mixed compositions are those having less than 80% total weight loss up to 250° C., as measured by thermal gravimetric analysis, at a heating rate of 10 C/min up to 500° C. in air. FIG. 1 illustrates the TGA weight loss curve of EDTA tetrasodium salt (Y═Na₄); and shows about 9.5% weight loss up to 250° C. In general materials having low weight loss are useful in polyamide compositions having higher melting points and processing temperatures.

The thermoplastic melt-mixed composition and thermoplastic articles derived therefrom comprise 10 to about 60 weight percent, and preferably about 12.5 to 55 weight percent, and 15 to 50 weight percent, of one or more reinforcement agents. The reinforcement agent may be any filler, but is preferably selected from the group consisting of calcium carbonate, glass fibers with circular cross-section, glass fibers with noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate and mixtures thereof.

Glass fibers with noncircular cross-section refer to glass fiber having a cross section having a major axis lying perpendicular to a longitudinal direction of the glass fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape, a rectangular shape; an elliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fiber are disclosed in EP 0 190 001 and EP 0 196 194. Preferably the reinforcing agent is selected from glass fibers with circular cross-section or glass fibers with noncircular cross-section.

The polymeric toughener is a polymer, typically an elastomer having a melting point and/or glass transition points below 25° C., or is rubber-like, i.e., has a heat of melting (measured by ASTM Method D3418-82) of less than about 10 J/g, more preferably less than about 5 J/g, and/or has a melting point of less than 80° C., more preferably less than about 60° C. Preferably the polymeric toughener has a weight average molecular weight of about 5,000 or more, more preferably about 10,000 or more, when measured by gel permeation chromatography using polyethylene standards.

The polymeric toughener can be a functionalized toughener, a nonfunctionalized toughener, or blend of the two.

A functionalized toughener has attached to it reactive functional groups which can react with the polyamide. Such functional groups are usually “attached” to the polymeric toughener by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber (such as an ethylene/α-olefin copolymer, an α-olefin being a straight chain olefin with a terminal double bond such a propylene or 1-octene) using free radical grafting techniques. The resulting grafted polymer has carboxylic anhydride and/or carboxyl groups attached to it. Ethylene copolymers are an example of a polymeric toughening agent wherein the functional groups are copolymerized into the polymer, for instance, a copolymer of ethylene and a (meth)acrylate monomer containing the appropriate functional group. Herein the term (meth)acrylate means the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl(meth)acrylate. In addition to ethylene and a functionalized (meth)acrylate monomer, other monomers may be copolymerized into such a polymer, such as vinyl acetate, unfunctionalized (meth)acrylate esters such as ethyl(meth)acrylate, n-butyl(meth)acrylate, i-butyl(meth)acrylate and cyclohexyl(meth)acrylate. Polymeric tougheners include those listed in U.S. Pat. No. 4,174,358, which is hereby incorporated by reference.

Another functionalized toughener is a polymer having carboxylic acid metal salts. Such polymers may be made by grafting or by copolymerizing a carboxyl or carboxylic anhydride containing compound to attach it to the polymer. Useful materials of this sort include Surlyn® ionomers available from E. I. DuPont de Nemours & Co. Inc., Wilmington, Del. 19898 USA, and the metal neutralized maleic anhydride grafted ethylene/α-olefin polymer described above. Preferred metal cations for these carboxylate salts include Zn, Li, Mg and Mn.

Polymeric tougheners useful in the invention include those selected from the group consisting of ethylene copolymers; ethylene/α-olefin or ethylene/α-olefin/diene copolymer grafted with an unsaturated carboxylic anhydride; core-shell polymers, and nonfunctionalized tougheners, as defined herein.

Herein the term ethylene copolymers include ethylene terpolymers and ethylene multi-polymers, i.e. having greater than three different repeat units. Ethylene copolymers useful as polymeric tougheners in the invention include those selected from the group consisting of ethylene copolymers of the formula E/X/Y wherein:
E is the radical formed from ethylene;
X is selected from the group consisting of radicals formed from

CH₂═CH(R¹)—C(O)—OR²

wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer;
Y is one or more radicals formed from monomers selected from the group consisting of carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoesters and potassium, sodium and zinc salts of said preceding acids, glycidyl(meth)acrylate, 2-hydroxyethyl(meth)acrylate, 2-isocyanatoethyl(meth)acrylate and glycidyl vinyl ether; wherein Y is from 0.5 to 35 weight % of the E/X/Y copolymer, and preferably 0.5-20 weight percent of the E/X/Y copolymer, and E is the remainder weight percent and preferably comprises 40-90 weight percent of the EDQY copolymer. It is preferred that the functionalized toughener contain a minimum of about 0.5, more preferably 1.0, very preferably about 2.5 weight percent of repeat units and/or grafted molecules containing functional groups or carboxylate salts (including the metal), and a maximum of about 15, more preferably about 13, and very preferably about 10 weight percent of monomers containing functional groups or carboxylate salts (including the metal). It is to be understood than any preferred minimum amount may be combined with any preferred maximum amount to form a preferred range. There may be more than one type of functional monomer present in the polymeric toughener, and/or more than one polymeric toughener. In one embodiment the polymeric toughener comprises about 2.5 to about 10 weight percent of repeat units and/or grafted molecules containing functional groups or carboxylate salts (including the metal).

It has been found that often the toughness of the composition is increased by increasing the amount of functionalized toughener and/or the amount of functional groups and/or metal carboxylate groups. However, these amounts should preferably not be increased to the point that the composition may crosslink (thermoset), especially before the final part shape is attained, and/or the first to melt tougheners may crosslink each other. Increasing these amounts may also increase the melt viscosity, and the melt viscosity should also preferably not be increased so much that molding is made difficult.

Nonfunctionalized tougheners may also be present in addition to a functionalized toughener. Nonfunctionalized tougheners include polymers such as ethylene/α-olefin/diene (EPDM) rubber, polyolefins including polyethylene (PE) and polypropylene, and ethylene/α-olefin (EP) rubbers such as ethylene/1-octene copolymer, and the like such as those commercial copolymers under the ENGAGE® brand from Dow Chemical, Midland Mich. Other nonfunctional tougheners include the styrene-containing polymers including acrylonitrile-styrene copolymer, acrylonitrile-butadiene-styrene copolymer, styrene-isoprene-styrene copolymer, styrene-hydrogenated isoprene-styrene copolymer, styrene-butadiene-styrene copolymer, styrene-hydrogenated butadiene-styrene copolymer, styrenic block copolymer, (are not the above listed polymers block or random polymers?) polystyrene. For example, acrylonitrile-butadiene-styrene, or ABS, is a terpolymer made by polymerizing styrene and acrylonitrile in the presence of polybutadiene. The proportions can vary from 15 to 35% acrylonitrile, 5 to 30% butadiene and 40 to 60% styrene. The result is a long chain of polybutadiene criss-crossed with shorter chains of polystyrene acrylonitrile). Other polymeric tougheners useful in the invention are having a (vinyl aromatic comonomer) core comprising an ethylene copolymer as disclosed above, the core optionally cross-linked and optionally containing a vinyl aromatic comonomer, for instance styrene; and a shell comprising another polymer that may include polymethyl methacrylate and optionally contain functional groups including epoxy, or amine. The core-shell polymer may be made up of multiple layers, prepared by a multi-stage, sequential polymerization technique of the type described in U.S. Pat. No. 4,180,529. Each successive stage is polymerized in the presence of the previously polymerized stages. Thus, each layer is polymerized as a layer on top of the immediately preceding stage. The minimum amount of polymeric toughener is 0.1, and preferably 0.5 weight percent. In other embodiments a minimum amount of polymeric toughener is 2, 4, or 6 weight percent, based on the total weight of the melt-mixed composition. The maximum amount of polymeric toughener is about 20, preferably about 15 and more preferably about 12 weight percent. In other embodiments a maximum amount of polymeric toughener is of 8, 5 or 3.5 weight percent, based on the total weight of the melt-mixed composition. It is to be understood than any minimum amount may be combined with any maximum amount to form a preferred weight range.

Polymeric tougheners are selected from the group consisting of ethylene copolymers; ethylene/α-olefin or ethylene/α-olefin/diene copolymer grafted with an unsaturated carboxylic anhydride; core-shell polymers, and nonfunctionalized tougheners, as defined herein.

Preferred polymeric tougheners are selected from the group consisting of:
(a) A copolymer of ethylene, glycidyl(meth)acrylate, and optionally one or more (meth)acrylate esters.
(b) An ethylene/α-olefin or ethylene/α-olefin/diene (EPDM) copolymer grafted with an unsaturated carboxylic anhydride such as maleic anhydride.
(c) A copolymer of ethylene, 2-isocyanatoethyl(meth)acrylate, and optionally one or more (meth)acrylate esters.
(d) a copolymer of ethylene and acrylic acid reacted with a Zn, Li, Mg or Mn compound to form the corresponding ionomer.

In one embodiment the thermoplastic melt-mixed composition and thermoplastic articles derived therefrom comprise 0.1 to 30 wt % of polymeric toughener. In one embodiment the thermoplastic melt-mixed composition and thermoplastic articles derived therefrom comprise 0.1 to 30 wt % of polymeric toughener with the proviso that the polymeric toughener comprises less than 5 weight percent of an ethylene copolymer, based on the total weight of the melt-mixed composition. In one embodiment the thermoplastic melt-mixed composition and thermoplastic articles derived therefrom comprise 0.1 to 3.5 wt % polymeric toughener.

In the present invention, the polymer composition of the present invention may also comprise other additives commonly used in the art, such other heat stabilizers or antioxidants referred to as “co-stabilizers”, antistatic agents, blowing agents, lubricants, plasticizers, and colorant and pigments.

Co-stabilizers include copper stabilizers, secondary aryl amines, hindered amine light stabilizers (HALS), hindered phenols, and mixtures thereof.

The melt-mixed compositions, as disclosed above may further comprise 0.01 to about 0.10 weight percent of copper (I) iodide stabilizer.

The melt-mixed compositions, as disclosed above may further comprise 0.1 to about 5.00 weight percent, and preferably about 0.5 to 4.0 weight percent of iron powder stabilizer. An appropriate source of iron powder is Shelfplus® O2 2400, a branded product, that refers to 20 weight percent finely divided iron powder dispersed in polyethylene, available from BASF, Germany.

Herein the thermoplastic composition is a mixture by melt-blending, in which all polymeric ingredients are adequately mixed, and all non-polymeric ingredients are adequately dispersed in a polymer matrix. Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing filler presents a long physical shape (for example, a long glass fiber), drawing extrusion molding may be used to prepare a reinforced composition.

The melt-mixed compositions, as disclosed above, are useful in increasing long-term thermal stability at high temperatures of molded or extruded articles made therefrom. The long-term heat stability of the articles can be assessed by exposure (air oven ageing) of 2 mm thick test samples at various test temperatures in an oven for various test periods of time. The oven test temperatures for the compositions disclosed herein may be 170° C. and 500, 1000, or 2000 hours test periods; 210° C. and 500 hours test periods; and 230° C. and 500 hours test periods. The test samples, after air oven ageing, are tested for tensile strength and elongation to break, according to ISO 527-2/1BA test method; and compared with unexposed controls having identical composition and shape, that are dry as molded (DAM). The comparison with the DAM controls provides the retention of tensile strength and/or retention of elongation to break, and thus the various compositions can be assessed as to long-term heat stability performance.

One embodiment is a molded or extruded thermoplastic article comprising the thermoplastic melt-mixed composition as disclosed in the above embodiments, wherein the polyamide resin comprises one or more Group (I) Polyamides, wherein 2 mm thick test bars, prepared from said melt-mixed composition and tested according to ISO 527-2/1BA, and exposed at a test temperature of 170° C. for a test period of 500 hours, in an atmosphere of air, have on average, a retention of tensile strength of at least 50 percent, and preferably at least 60, 70, 80, and 90%, as compared with that of an unexposed control of identical composition and shape.

One embodiment is a molded or extruded thermoplastic article comprising the thermoplastic melt-mixed composition, as disclosed in the above embodiments, wherein the polyamide resin comprises one or more Group (II) Polyamides, wherein 2 mm thick test bars, prepared from said melt-mixed composition and tested according to ISO 527-2/1BA, and exposed at a test temperature of 210° C. for a test period of 500 hours, in an atmosphere of air, have on average, a retention of tensile strength of at least 50 percent, and preferably at least 60, 70, 80, and 90%, as compared with that of an unexposed control of identical composition and shape.

One embodiment is a molded or extruded thermoplastic article comprising the thermoplastic melt-mixed composition, as disclosed in the above embodiments, wherein the polyamide resin comprises a one or more polyamides selected from the group consisting of Group (IIB) Polyamides, Group (III) Polyamides, Group (IV) Polyamides, Group (V) Polyamides, and Group (VI) Polyamides, wherein 2 mm thick test bars, prepared from said melt-mixed composition and tested according to ISO 527-2/1 BA, and exposed at a test temperature of 230° C. for a test period of 500 hours, in an atmosphere of air, have on average, a retention of tensile strength of at least 50 percent, and preferably at least 60, 70, 80, and 90%, as compared with that of an unexposed control of identical composition and shape

In another aspect, the present invention relates to a method for manufacturing an article by shaping the melt-mixed compositions. Examples of articles are films or laminates, automotive parts or engine parts or electrical/electronics parts. By “shaping”, it is meant any shaping technique, such as for example extrusion, injection molding, thermoform molding, compression molding or blow molding. Preferably, the article is shaped by injection molding or blow molding.

The molded or extruded thermoplastic articles disclosed herein may have application in many vehicular components that meet one or more of the following requirements: high impact requirements; significant weight reduction (over conventional metals, for instance); resistance to high temperature; resistance to oil environment; resistance to chemical agents such as coolants; and noise reduction allowing more compact and integrated design. Specific molded or extruded thermoplastic articles are selected from the group consisting of charge air coolers (CAC); cylinder head covers (CHC); oil pans; engine cooling systems, including thermostat and heater housings and coolant pumps; exhaust systems including mufflers and housings for catalytic converters; air intake manifolds (AIM); and timing chain belt front covers. As an illustrative example of desired mechanical resistance against long-term high temperature exposure, a charge air cooler can be mentioned. A charge air cooler is a part of the radiator of a vehicle that improves engine combustion efficiency. Charge air coolers reduce the charge air temperature and increase the density of the air after compression in the turbocharger thus allowing more air to enter into the cylinders to improve engine efficiency. Since the temperature of the incoming air can be more than 200° C. when it enters the charge air cooler, it is required that this part be made out of a composition maintaining good mechanical properties under high temperatures for an extended period of time.

The present invention is further illustrated by the following examples. It should be understood that the following examples are for illustration purposes only, and are not used to limit the present invention thereto.

### Methods

Compounding Method

All Examples and Comparative Examples were prepared by melt blending the ingredients listed in the Tables in a 30 mm twin screw extruder (ZSK 30 by Coperion) operating at about 280° C. for Polyamide A and PA66 compositions and 310° C. barrel setting for Polyamide B compositions, using a screw speed of about 300 rpm, a throughput of 13.6 kg/hour and a melt temperature measured by hand of about 320-355° C. for the all compositions. The glass fibers were added to the melt through a screw side feeder. Ingredient quantities shown in the Tables are given in weight percent on the basis of the total weight of the thermoplastic composition.

The compounded mixture was extruded in the form of laces or strands, cooled in a water bath, chopped into granules and placed into sealed aluminum lined bags in order to prevent moisture pick up.

Mechanical Tensile Properties

Mechanical tensile properties, i.e. E-modulus, stress at break (Tensile strength) and strain at break (elongation at break) were measured according to ISO 527-2/1BA.

Measurements were made on 2 mm thick injection molded ISO tensile bars at a testing speed of 5 mm/min. Mold temperature for PA 6T/DT test specimens was 145-150° C.; mold temperature for PA 6T/66 test specimens was 90-100° C.; and melt temperature was 325-330° C. for both resins.

Air Oven Ageing (AOA)

The test specimens were heat aged in a re-circulating air ovens (Heraeus type UT6060) according to the procedure detailed in ISO 2578. At various heat aging times, the test specimens were removed from the oven, allowed to cool to room temperature and sealed into aluminum lined bags until ready for testing. The tensile mechanical properties were then measured according to ISO 527 using a Zwick tensile instrument. The average values obtained from 5 specimens are given in the Tables. Retention of tensile strength (TS) and elongation at break (EL) corresponds to the percentage of the tensile strength and elongation at break after heat aging for 500 hours in comparison with the value of specimens non-heat-aged control specimens considered as being 100%.

### Materials

Polyamide A refers to PA66/6T (75/25 molar ratio repeat units) with amine ends approximately 80 meq/kg, having a typical relative viscosity (RV) of 41, according to ASTM D-789 method, and a typical melt point of 268° C., that was provided according to the following procedure: Polyamide 66 salt solution (3928 lbs. of a 51.7 percent by weight with a pH of 8.1) and 2926 lbs of a 25.2% by weight of polyamide 6T salt solution with a pH of 7.6 were charged into an autoclave with 100 g of a conventional antifoam agent, 20g of sodium hypophosphite, 220g of sodium bicarbonate, 2476 g of 80% HMD solution in water, and 1584 g of glacial acetic. The solution was then heated while the pressure was allowed to rise to 265 psia at which point, steam was vented to maintain the pressure at 265 psia and heating was continued until the temperature of the batch reached 250° C. The pressure was then reduced slowly to 6 psia, while the batch temperature was allowed to further rise to 280-290° C. The pressure was then held at 6 psia and the temperature was held at 280-290° C. for 20 minutes. Finally, the polymer melt was extruded into strands, cooled, and cut into pellets. The resulting polyamide 66/6T is referred to herein as Polyamide A

Glass Fiber B refers to CPIC 301HP chopped glass fiber available from Chongqing Polycomp International Corp. (CPIC), Peoples Republic of China.

Licowax OP is a lubricant manufactured by Clariant Corp., Charlotte, N.C.

Kenamide E180 refers to a fatty acid amide lubricant available from Chemtura Corporation.

Black Pigment A refers to 40 wt % nigrosine black pigment concentrate in a PA66 carrier.

Black Pigment B refers to 25 wt % carbon black in PA6 carrier.

Cu heat stabilizer refers to a mixture of 7 parts of potassium iodide and 1 part of copper iodide in 0.5 part of a stearate wax binder.

Tartaric acid iron (III) salt was available from Aldrich Chemical Co., Milwaukee, Wis.

Tartaric acid potassium sodium salt was available from Aldrich Chemical Co., Milwaukee, Wis.

Malic acid disodium salt was available from Aldrich Chemical Co., Milwaukee, Wis.

Citric acid iron (III) salt was available from Aldrich Chemical Co., Milwaukee, Wis.

Citric acid trisodium salt was available from Aldrich Chemical Co., Milwaukee, Wis.

TABLE 4
Citric Acid Salts in PA66/6T

| | Example | | | | |
|---|---|---|---|---|---|
| | C-1 | C-2 | 1 | 2 | 3 |
| Polyamide A (66/6T) | 64.45 | 61.75 | 63.06 | 62.06 | 61.06 |
| Glass Fiber B [CPIC] | 35.00 | 35.00 | 35.00 | 35.00 | 35.00 |
| Licowax OP | 0.25 | 0.25 | | | |
| Kemamide E180 | | | 0.10 | 0.10 | 0.10 |
| Cu Heat Stabilizer | 0.30 | | | 0.45 | |
| Citric Acid | | 3.00 | | | |
| Citric Acid Trisodium | | | 3.00 | 3.00 | |
| Salt | | | | | |
| Citric Acid Iron(III) Salt | | | | | 3.00 |

Tensile Properties, Dry-As-Molded

| | | | | | |
|---|---|---|---|---|---|
| Tensile Strength [MPa] | 206 | 154 | 171 | 178 | 172 |
| Elongation at Break [%] | 5.4 | 4.9 | 6.7 | 6.3 | 6.5 |

Tensile Properties, 500 hrs at 230° C.

| | | | | | |
|---|---|---|---|---|---|
| Tensile Strength [MPa] | 94 | 72 | 126 | 189 | 192 |
| Tensile Strength | 46% | 47% | 74% | 106% | 112% |
| Retention | | | | | |
| Elongation at Break [%] | 1.7 | 1.8 | 4.3 | 5.3 | 5.7 |
| Elongation Retention | 32% | 37% | 63% | 85% | 87% |

Tensile Properties, 1000 hrs at 230° C.

| | | | | | |
|---|---|---|---|---|---|
| Tensile Strength [MPa] | 12 | 49 | 72 | 176 | 191 |
| Tensile Strength | 6% | 32% | 42% | 99% | 111% |
| Retention | | | | | |
| Elongation at Break [%] | 0.4 | 2.4 | 3.2 | 4.5 | 5.5 |
| Elongation Retention | 6% | 49% | 48% | 72% | 84% |
| Experiment | 44-1 | 44-6 | 49-3 | 49-2 | 49-4 |

TABLE 5
Malic and Tartaric Acid Salts in PA66/6T

| | Example | | | |
|---|---|---|---|---|
| | C-1 | 4 | 5 | 6 |
| Polyamide A (66/6T) | 64.45 | 62.06 | 60.47 | 60.47 |
| Glass Fiber B | 35.00 | 35.00 | 35.00 | 35.00 |
| Licowax OP | 0.25 | 0.25 | | |
| Kemamide E180 | | | 0.10 | 0.10 |
| Black Pigment A (40% nigrosine | | 0.69 | 0.60 | 0.60 |
| in PA66) | | | | |
| Black Pigment B (25% carbon | | | 0.83 | 0.83 |
| black in PA6) | | | | |
| Cu Heat Stabilizer | 0.30 | | | |
| Malic Acid Disodium Salt | | 2.00 | | |
| Tartaric Acid Potassium Sodium | | | 3.00 | |
| Salt | | | | |
| Tartaric Acid Iron(III) Salt | | | | 3.00 |

Tensile Properties, Dry-As-Molded

| | | | | |
|---|---|---|---|---|
| Tensile Strength [MPa] | 206 | 197 | 168 | 177 |
| Elongation at Break [%] | 5.4 | 5.4 | 5.6 | 6.7 |

Tensile Properties, 500 hrs at 230° C.

| | | | | |
|---|---|---|---|---|
| Tensile Strength [MPa] | 94 | 151 | 118 | 173 |
| Tensile Strength Retention | 46% | 77% | 70% | 98% |
| Elongation at Break [%] | 1.7 | 3.7 | 3.3 | 5.2 |
| Elongation Retention | 32% | 67% | 58% | 77% |

Tensile Properties, 1000 hrs at 230° C.

| | | | | |
|---|---|---|---|---|
| Tensile Strength [MPa] | 12 | N/A | 77 | 135 |
| Tensile Strength Retention | 6% | N/A | 99% | 111% |
| Elongation at Break [%] | 0.4 | N/A | 2.3 | 4.8 |
| Elongation Retention | 6% | N/A | 40% | 71% |

1. A thermoplastic melt-mixed composition comprising:
a) a polyamide resin selected from the group consisting of Group (III) polyamides having a melting point of greater than 230° C., and comprising:
(aa) about 20 to about 35 mole percent semi-aromatic repeat units derived from monomers selected from one or more of the group consisting of:
i) aromatic dicarboxylic acids having 8 to 20 carbon atoms and aliphatic diamines having 4 to 20 carbon atoms; and
(bb) about 65 to about 80 mole percent aliphatic repeat units derived from monomers selected from one or more of the group consisting of:
ii) an aliphatic dicarboxylic acid having 6 to 20 carbon atoms and said aliphatic diamine having 4 to 20 carbon atoms; and
iii) a lactam and/or aminocarboxylic add having 4 to 20 carbon atoms;
b) about 1.0 to about 5.0 weight percent of a polyacid metal salt selected from the group consisting of citrate metal salts, malate metal salts, tartarate metal salts and combinations thereof;
c) 10 to 60 weight percent reinforcing agent; and
d) 0 to 30 weight percent polymeric toughener;
wherein the polyacid metal salt comprises a counter-ion selected from the group consisting of copper (I), copper (II), iron (II), Iron (III), or combinations thereof; and
wherein the weight percent of components a), b), c) and d) are based on the total weight of the thermoplastic melt-mixed composition.

2. (canceled)

3. The thermoplastic melt-mixed composition of claim 1 wherein the reinforcing agent comprises one or more reinforcement agents selected from the group consisting of calcium carbonate, glass fibers with circular cross-section, glass fibers with noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate and mixtures thereof.

4. (canceled)

5. The thermoplastic melt-mixed composition of claim 1 wherein the polyamide resin comprises hexamethylene adipamide/hexamethylene terephthalamide copolyamide.

6. (canceled)

7. A molded or extruded thermoplastic article comprising the thermoplastic melt-mixed composition of claim 1, wherein 2 mm thick test bars, prepared from said melt-mixed composition and tested according to ISO 527-2/1BA, and exposed at a test temperature of 230° C. for a test period of 500 hours, in an atmosphere of air, have on average, a retention of tensile strength of at least 50 percent, as compared with that of an unexposed control of identical composition and shape.

8. The molded or extruded thermoplastic article of claim 7 that is a charge air cooler (CAC); cylinder head cover (CHC); oil pan; engine cooling system, including thermostat and heater housing and coolant pump; exhaust system including muffler and housing for catalytic converter; air intake manifold (AIM); and timing chain belt front cover.
